(19) United States
(12) Patent Application Publication
(10) Pub. No.: US 2006/0255752 A1
(43) Pub. Date: Nov. 16, 2006

(54) Flash driving apparatus

(76) Inventors: Kwok Ying Joseph Chow, HONG KONG (CN); Tan Cheung Ngo, Hong Kong (CN); Yu Jiang, Guangdong (CN); Lin Ni, Guangxi (CN)

Correspondence Address: Peter J Phillips;Cooper & Dunham, 1185 Avenue of the Americas, New York, NY, 10036, US

(21) Appl. No.: 10/560,213

(22) PCT Filed: Nov. 7, 2003
(86) PCT No.: PCT/CN03/00972

§ 371 Date: Apr. 25, 2006

(30) Foreign Application Priority Data
Jun. 11, 2003 (CN) 03265635.1

(51) Int. Cl. H05B 39/00

(52) U.S. Cl. 315/312

(57) ABSTRACT

A flash driving apparatus that eliminates the limitation of setting the flash condition as required of the prior art is provided in the utility model, including a power supply, a control IC, a flash member and a switch module, wherein the switch that is connected with the trigging pin TG of the control IC is provided with two or more contacts, and a condition recognizer that will switch into conduction or cutoff according to a given condition is connected between the switch and the trigging pin TG; With this configuration, when the movement of the switch between the two contacts meets the condition set in the condition recognizer, the condition recognizer switches into conduction and sends the trigging signal to the control IC, or alternatively, the condition recognizer switches into cutoff and stops sending the trigging signal to the control IC such that the apparatus produces the effect of flash when the vibration of the switch meets the given condition.

### FIELD OF THE UTILITY MODEL

The present utility model relates a flash apparatus, especially a driving apparatus of the flash apparatus.

### BACKGROUND OF THE UTILITY MODEL

The flash apparatus fixed on clothes and shoes has the function of decoration on one hand, and on the other hand it arouses the attention of drivers or other people to the person who wears the clothes or shoes with flash devices, so as to ensure his or her safety.

The existing flash apparatus uses luminescent diode, incandescent lamp, electroluminescent element or other luminescent components as light source of flash, as shown in its circuit frame FIG. 1, the positive electrode of the power supply is connected to the positive electrode of the controlling IC in reference of pin VDD, while the negative electrode of the power supply is connected to the ground of the controlling IC in reference of pin GND; between the OSCI and OSCO ends of the controlling IC is connected an oscillator resistor which produces oscillator signals, one end of the luminescent diodes LED1, LED2, LED3 is connected respectively to the output ends OUT1, OUT2, OUT3 of the controlling IC, whereas the other end is connected to the positive electrode of the power supply; the trigging pin TG of the controlling IC is connected with an elastic switch or trigging switch that sends trigging signals; the said trigging switch or elastic switch is single contact type, when the trigging switch or elastic switch is triggered, it produces trigging signals, and the luminescent components of the flash apparatus send out flashes according to settings. Although the flash driving apparatus with this type of structure is able to produce flash, it flashes as long as the trigging switch or elastic switch produces vibration, unable to produce flash when the vibration of the switch meets the preset given condition.

### SUMMARY OF THE UTILITY MODEL

The purpose of the utility model is to provide a flash driving apparatus which produces flash when the vibration of the switch meets the given condition; its further purpose is to provide different voltages for luminescent components requiring different voltages; its still further purpose is to provide a charging circuit for more convenient use.

The flash driving apparatus disclosed by the present utility model includes a power supply, a controlling IC, a flash member and a switch module, wherein the switch that is connected with the trigging pin TG of the controlling IC is provided with two or more contacts, and a condition recognizer that will switch into conduction or cutoff according to a given condition is connected between the switch and the trigging pin TG;

The said condition recognizer includes an NAND gate, the output of the gate is connected to the trigging pin TG of the controlling IC, one pin of the input comparator end of the gate is connected to one contact of the switch and is connected to ground or the negative electrode of the power supply, the other pin of the input comparator end of the gate is connected to the other contact of the switch through a capacitor whose two ends are connected to ground or to the negative electrode of the power supply.

In the flash driving apparatus disclosed by the present utility model, the switch connected with the trigging pin TG of the controlling IC is provided with two or more contacts, and a condition recognizer that will switch into conduction or cutoff according to a given condition is connected between the switch and the trigging pin TG; when the movement of the switch between the two contacts meets the condition set in the condition recognize, the condition recognizer switches into conduction and sends the trigging signal to the controlling IC, or alternatively, the condition recognizer switches into cutoff and stops sending the trigging signal to the controlling IC such that the apparatus produces the effect of flash when the vibration of the switch meets the given condition.

### BRIEF DESCRIPTION OF THE DRAWINGS

More detailed explanations are made in the following with diagrams and embodiments:

FIG. 1 is schematic diagram of existing technology.

FIG. 2 is schematic diagram of the present utility model.

FIG. 3 is an embodiment of the said switch of the utility model.

FIG. 4 is another embodiment of the said switch of the utility model.

FIG. 5 is schematic diagram of the charging circuit of the utility model.

FIG. 6 is schematic diagram of the voltage division circuit of the utility model.

FIG. 7 is schematic diagram of the voltage division circuit of the utility model.

FIG. 8 is another schematic diagram of the present utility model.

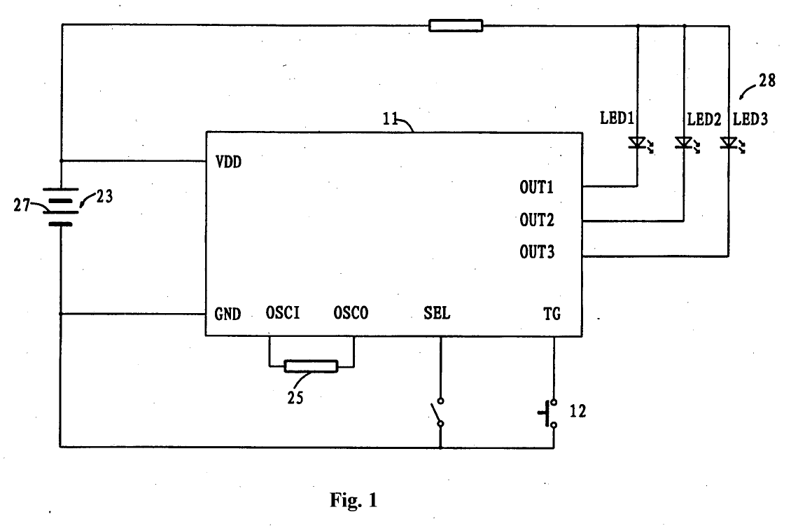

### DETAILED DESCRIPTION OF THE PREFERRED EMBODIMENTS

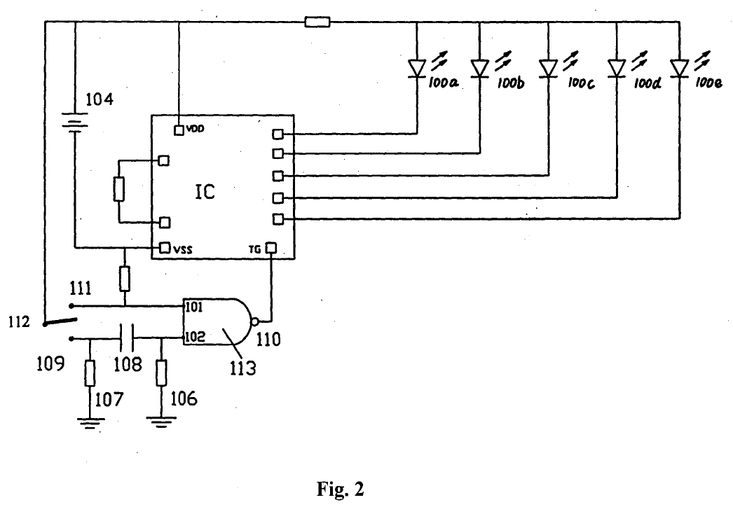

The flash driving apparatus disclosed by the present utility model, as illustrated in FIG. 2, includes a power supply 104, a controlling IC, flash members 100a, 100b, 100c, 100d, 100e and the switch module, the switch connected with the trigging pin TG of the controlling IC is provided with two or more contacts 109,111, and a condition recognizer that will switch into conduction or cutoff according to a given condition is connected between the switch and the trigging pin TG; the said flash members can be luminescent triode, incandescent lamp or electroluminescent element etc.

The said condition recognizer includes a NAND gate 113, the output 110 of gate 113 is connected to the trigging pin TG of the controlling IC, the pin of the comparator end 101 of gate 113 is connected to a contact 111 of the switch 112, and is connected to ground or to the negative electrode of the power supply, another pin 102 of the comparator end of the NAND gate 113 is connected to another contact 109 through a capacitor 108, two ends of the capacitor are grounded or connected to the negative electrode of the power supply; on the lead wire are connected with resistors 106,107 with according resistance values, under the effect of vibration, as the switch 112 contacts the contact 109 which is connected with capacitor 108, the capacitor is charged, so that the input comparator of gate 113 which is connected to it is in high electrical level; under the effect of vibration, switch 112 gets off this contact 109, the capacitor 108 discharges, and the electric level of the input comparator end of gate 113 drops; if vibration is in high speed to reach or exceed the set value, the switch 112 contacts another contact 111, and charges the other input comparator pf gate 113 to make it reach high electric level, now the input comparator end of gate 113 which is connected with capacitor 108 still remains a high electric level due to the effect of capacitor 108, gate 113 switches into conduction; if vibration speed is less than set value, the electric level of the input comparator end of gate 113 which is connected with capacitor 108 will drop to below the set value after capacitor 108 discharges more through the lead wires at two ends, as switch 112 contacts the other contact 111, the pin 102 of the input comparator of the gate is in low electric level, while the other pin 101 is in high electric level, thus gate 113 switches into cutoff.

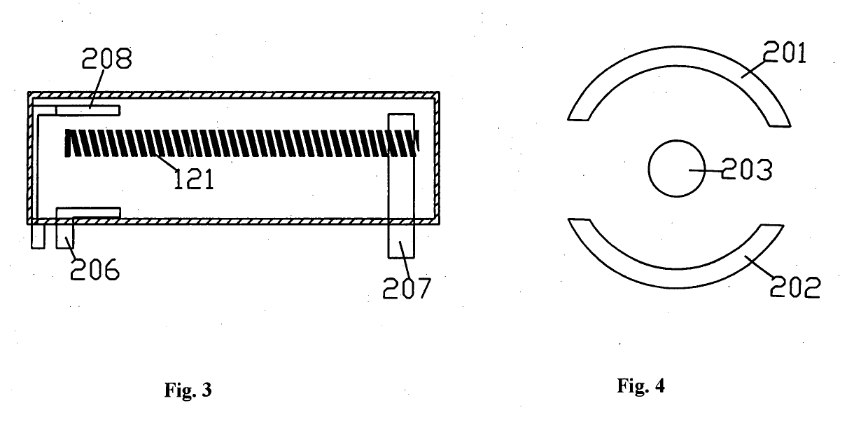

The said switch 112 is an elastic one, as shown in FIG. 3, including a spring 121. One end of the spring is fixed on the conducting saddle 207 which is connected to the external circuit; at the free end of spring 121 are fixed two or more conducting slabs 206, 208 which constitute the contacts of the switch, the conducting slabs are connected to the external circuit.

The said switch 112 can also be of another structure, as shown in FIG. 4, spring 203 is sleeved with two or more conducting rings 201,202 which are laid around spring 203 and constitute two or more contacts of switch 112 and are connected to external circuit; this structure is convenient for installation of elastic switch, free from limitation of the direction of elastic vibration.

Naturally the above stated spring can also be equivalently substituted with a conducting object that is able to oscillate between the conductors under vibration.

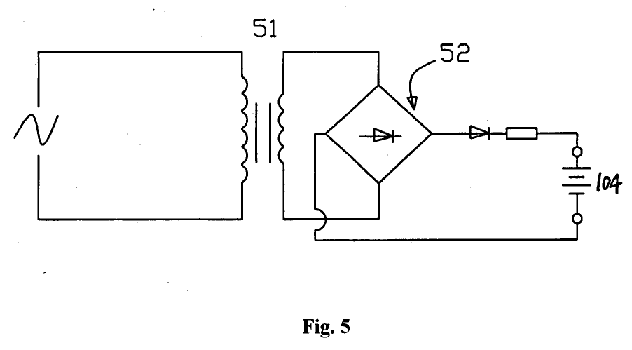

In order to charge the power supply so as to reduce frequency of battery replacement and prolong the service life of the flash apparatus, a charging circuit can be added to the power supply. As shown in FIG. 5, the battery is connected with a rectifying circuit 52 which is connected to the AC supply through transformer 51.

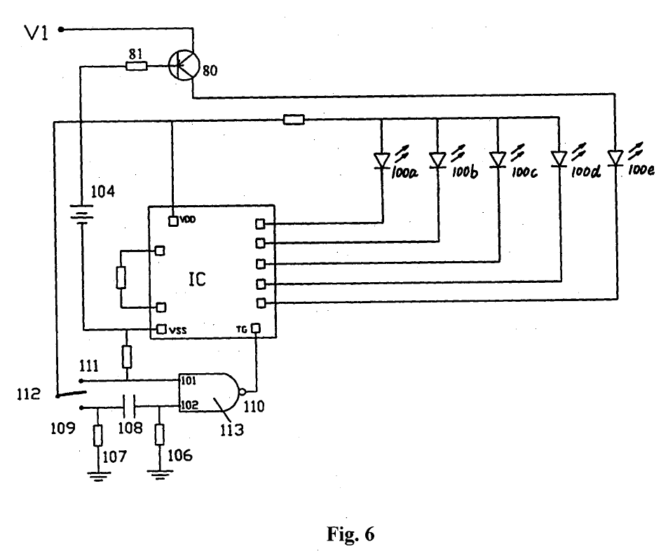

Flash members of different colors and types may have different working voltages, for instance, red and white luminescent triodes have low working voltages, whereas blue luminescent triodes have relatively high working voltage. To solve this problem, two power supplies are provided as shown in FIG. 6, the first power supply 104 and the second power supply V1; the first power supply is connected through the controlling IC to the low voltage flash members 100a, 100b, 100c, 100d; the high voltage flash member 100e is connected to the collector of triode 80 whose emitter is connected to second power supply V1, whose base is connected to the first power supply 104 through a resistance-capacitance resistor 81, thus the flash member 100e is provided with high voltage.

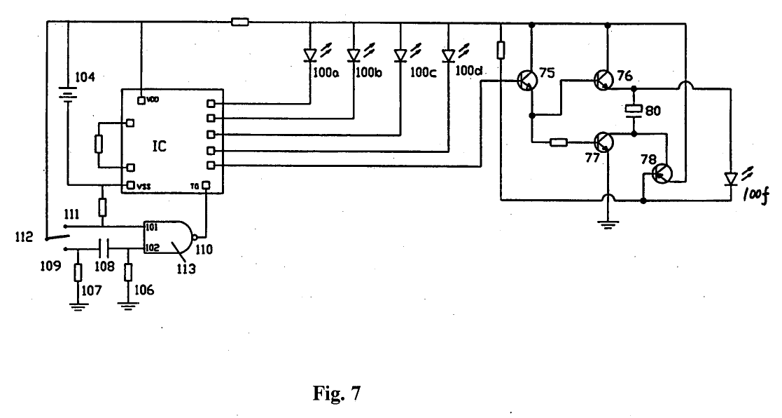

Another solution to the above stated problem is to add a boost circuit at the places of the high voltage flash members, as shown in FIG. 7, the boost circuit includes triodes 75, 76, 77, 78 and capacitor 80; the base of the switch triode 75 is connected to the output pin of controlling IC, its collector is connected to power supply, its emitter is connected to the base of the driving triode 76, and is connected to the ground triode 77 through a resistance-capacitance resistor; the collector of the driving triode 76 is connected to power supply, its emitter is connected to the high voltage flash member 100f and is connected to the positive electrode of capacitor 80, the negative electrode of capacitor 80 is connected to the collector of ground triode 77 and is connected to the collector of the charging triode 78; the emitter of the ground triode 77 is grounded or connected to the negative electrode of the power supply, the base of the charging triode 78 is connected to the power supply through a resistance-capacitance resistor and is connected to flash member 100f, its emitter is connected to power supply; when the base of the switch triode 75 is in high electric level, the driving triode 76, the ground triode 77 and the charging triode 78 come into conductance; capacitor 80 is charged from the positive electrode of the power supply, when the electric level of the base of the charging triode 75 is drawn low, the charging triode 78 will become conducted, the current from the positive electrode of the power supply flows to the negative electrode of capacitor 80 through the collector of triode 78, capacitor 80 starts to discharge, so as to provide high voltage to flash members require high voltage.

Another embodiment of the flash driving apparatus disclosed by the present utility model is shown in FIG. 8, its function and circuit is similar to the embodiment indicated in FIG. 2, the main difference in the circuit is that between the contacts 111, 109 of its switch 112 and the VSS of the power supply are respectively connected with capacitors 114, 115 which match the electric levels the two contacts receive, so that the circuit will become more stable with more satisfactory results.

The present utility is not limited to the above stated embodiments.

1. A driving apparatus including a power supply (104), a controlling IC, flash members (100a, 100b, 100c, 100d, 100e), and a switch module is characterized by that the said switch (112) connected with the trigging pin TG of the controlling IC is provided with two or more contacts (109,111), and a condition recognizer that will switch into conduction or cutoff according to a given condition is connected between the switch (112) and the trigging pin TG.

2. A flash driving apparatus according to claim 1, characterized by that the said condition recognizer includes a NAND gate (113), the output of gate (113) is connected to the trigging pin TG of the controlling IC, the pin of the comparator end (101) of gate (113) is connected to a contact (111) of the switch (112), and is connected to ground or to the negative electrode of the power supply, another pin (102) of the comparator end of the NAND gate (113) is connected to another contact (109) through a capacitor (108), two ends of the capacitor are grounded or connected to the negative electrode of the power supply.

3. A flash driving apparatus according to claim 1, characterized by that the said switch (112) is an elastic one, including a spring (121), one end of the spring is fixed on the conducting saddle (207) which is connected to the external circuit; at the free end of spring (121) are fixed two or more conducting slabs (206,208) which constitute the contacts of the switch (112), the conducting slabs (206,208) are connected to the external circuit.

4. A flash driving apparatus according to claim 1, characterized by that the said switch (112) is an elastic one, spring (203) are sleeved with two or more conducting rings (201,202), which are laid around spring (203) and constitute two or more contacts of switch (112) and are connected to external circuit.

5. A flash driving apparatus according to claim 1, characterized by that the said power supply is connected with a charging circuit.

6. A flash driving apparatus according to claim 1, characterized by that two said power supplies are provided: the first power supply (104) and the second power supply (V1); the first power supply (104) is connected through the controlling IC to the low voltage flash members (100a, 100b, 100c, 100d); the high voltage flash member (100e) is connected to the collector of triode (80) whose emitter is connected to second power supply (V1), whose base is connected to the first power supply (104) through a resistance-capacitance resistor (81), thus the flash members are provided with high voltage.

7. A flash driving apparatus according to claim 1, characterized by that a boost circuit is added at the place of the flash member of (100e).
